(19) United States
(12) Patent Application Publication
(10) Pub. No.: US 2004/0158541 A1
(43) Pub. Date: Aug. 12, 2004

(54) Power savings financial compensation control method and system

(75) Inventors: Joseph C. Notarianni, Naples, FL (US); Timothy Yablonowski, Naples, FL (US)

Correspondence Address: Craig A. Summerfield, Brinks Hofer Gilson & Lione, P.O. Box 10395, Chicago, IL, 60610, US

(73) Assignee: Ultrawatt Energy Systems, Inc.

(21) Appl. No.: 10/361,042

(22) Filed: Feb. 6, 2003

(51) Int. Cl. G06F 17/60

(52) U.S. Cl. 705/412

(57) ABSTRACT

Methods and systems provide power savings control based on financial compensation. The power reduction system is configured to automatically account for a desired or target power savings over a time period. The system compensates for previous or current decreases in power reduction for one or more loads to satisfy an aggregate target power savings by the end of a time period.

### BACKGROUND

The present invention relates to electronic power regulation and control. In particular, methods and systems for controlling energy consumption of a load are provided.

Various devices are available for reducing the energy consumed by a load, such as lighting. The devices may be purchased or may be used as part of a contractual agreement. For example, the devices are provided in exchange for an amount of money based on expected savings. The agreement may provide for a certain amount of money based on savings over a time period, such as a year. The user receives a reduced energy bill or cost and pays only part of the savings to the provider of the equipment. However, device failure, power fluctuations, changes in the load or usage variance may result in less than expected savings over the time period. As a result, a penalty may be charged to the provider of the devices or the user may be unhappy with the performance, canceling the agreement for future years. The possible variance also results in difficulty by the equipment provider to obtain insurance or bonds based on expected income.

### BRIEF SUMMARY

The present invention is defined by the following claims, and nothing in this section should be taken as a limitation on those claims. By way of introduction, the preferred embodiments described below include methods and systems for power savings financial compensation control. A power reduction system is configured to automatically account for a desired or target power savings over a time period. The system compensates for previous or current decreases in power reduction.

In a first aspect, a system for controlling financial compensation based on reduced energy consumption in a power savings mode is provided. An alternating current source connects with a load. A control unit connects with the load. The control unit is operative to reduce an amount of power output to the load from the alternating current source and automatically alter the reduction of the amount of power output as a function of a power savings over a time period.

In a second aspect, a method for controlling financial compensation based on reduced energy consumption in a power savings mode is provided. An amount of power output to a load from an AC source is reduced. The amount of power output is altered as a function of an aggregate target power savings over a time period.

In a third aspect, another method for controlling financial compensation based on reduced energy consumption in a power savings mode is provided. Power reductions are monitored for each of a plurality of loads. A total power reduction is calculated from the power reductions. The power reductions are automatically altered for multiple of the plurality of loads in response to a decrease in the power reduction provided to one of the plurality of loads. The alteration is a function of a target power savings and the total power reduction.

Further aspects and advantages of the invention are discussed below in conjunction with the preferred embodiments.

### BRIEF DESCRIPTION OF THE DRAWINGS

The components and the figures are not necessarily to scale, emphasis instead being placed upon illustrating the principles of the invention. Moreover, in the figures, like reference numerals designate corresponding parts throughout the different views.

FIG. 1 is a block diagram of one embodiment of a system for controlling financial compensation based on reduced energy consumption in a power savings mode; and

FIG. 2 is a flow chart diagram of one embodiment of a method for operating the system of FIG. 1.

### DETAILED DESCRIPTION OF THE DRAWINGS AND PRESENTLY PREFERRED EMBODIMENTS

An amount of power reduction is automatically adjusted to provide an aggregate target power savings over a time period. Where a failure or other occurrence may result in less power savings within the time period, the amount of current reduction is altered to compensate. In response to the target power savings over the time period, such as a year, the system automatically avoids penalties or other undesired consequences of not saving the desired amount of power.

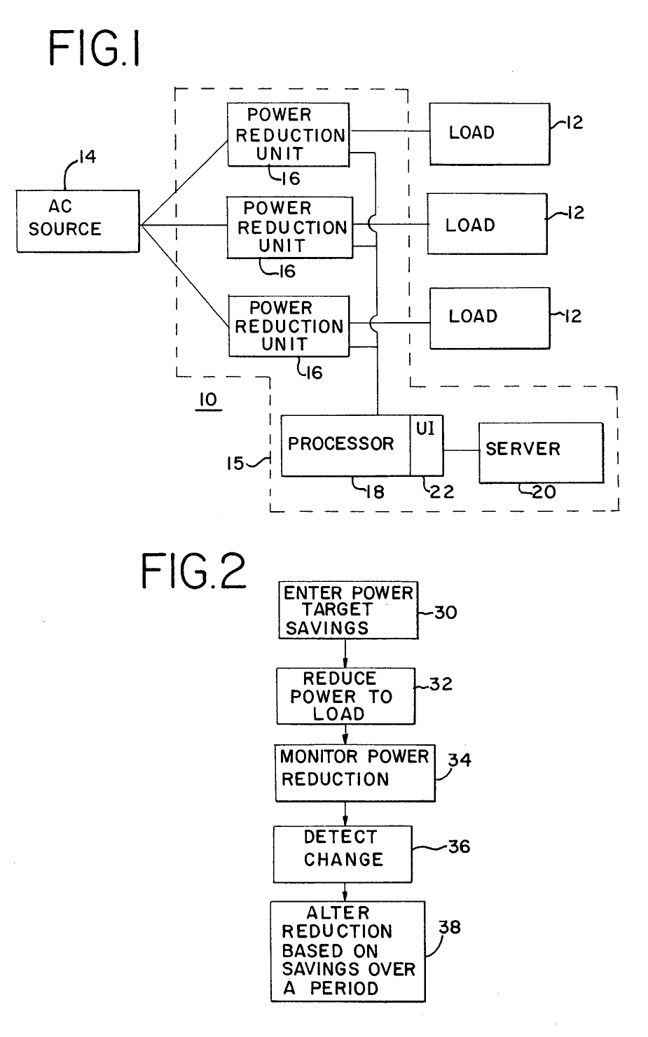

FIG. 1 shows a system 10 for controlling financial compensation based on reduced energy consumption in a power savings mode. The system 10 includes one or more loads 12, an alternating current (AC) source 14 and a control unit 15. The control unit 15 comprises one or more power reduction units 16, a processor 18 with a user interface 22 and a server 20. Additional, fewer or different components may be used. For example, a single load 12 connects through a single power reduction unit 16 to the AC source 14 without further control unit components. As another example, multiple AC sources 14 are provided. As yet another example, multiple loads 12 connect with a single power reduction unit 16.

The AC source 14 comprises a source of line voltage, such as provided by a utility, an alternating current generator, breaker box or circuit panel, a source of direct current with a DC to AC converter, or another source. The loads 12 comprise the same or different devices, such as motors, transformers, lighting circuits, lamps or other electrical loads. For lighting loads, each load 12 comprises one or more lamps. For example, halogen, incandescent, ballasted fluorescent or ballasted high intensity discharge lighting loads are provided. Magnetically ballasted or electronically ballasted lighting loads or lamps may be used. While multiple loads 12 are shown, the system 10 may include only one load 12. The loads 12 may comprise single or multiple load devices with a combination of resistive, capacitive and inductive elements. In some embodiments, each load 12 comprises different devices, such as different types of lighting loads. For example, a halogen, incandescent and ballasted fluorescent lighting loads are provided as separate lamps on a same circuit or load 12.

The control unit 15 connects with the loads 12. In one embodiment, the control unit 15 comprises just one or more power reduction units 16. In other embodiments, one or both of the processor 18 and the server 20 are included in the control unit 15. The processor 18 and/or the server 20 connect with one or more power reduction units 16. Additional processors 18, servers 20 or other control devices may be used, such as in groupings associated with different facilities or different circuits of a same facility.

The power reduction units 16 comprise power savings units or voltage reduction systems. For example, the power reduction units 16 each comprise an AC power switch or switches connected in parallel with a capacitor. The power switch and capacitor are connected in series in between the AC source 14 and the loads 12. Control circuitry operates the switch to reduce the root mean square voltage or power provided to the loads 12. Examples of such power reduction units are disclosed in U.S. Pat. Nos. 5,583,423; 5,754,036 and 6,172,489, assigned to the assignee of the present invention, the disclosures of which are incorporated herein by reference. In one embodiment, the power reduction units 16 in the above described patents are implemented with digital circuitry, such as two processors or application specific integrated circuits (e.g. one power controller and one user interface and/or communication processors) connected with analog components. In alternative embodiments, autotransformers, Thyristor switch systems, or other power reduction or savings units may be used. Where lighting loads are controlled, the power reduction unit 16 comprises a lighting control unit.

The power reduction units 16 reduce a power characteristic, such as the root means square voltage or current, provided to the loads 12. For example in the switch embodiment, the switch of the power reduction units 16 is turned off prior to a zero crossing of a half cycle of the AC cycle waveform, passing current through the parallel capacitor, and turned on at the next zero crossing. Other switch turn-on and off timings may be used. As an example in the autotransformer embodiment, a tap location of the autotransformer is changed, altering the peak voltage.

The amount of power reduction is selected as a function of various characteristics, such as a desired instant power savings, target aggregate power savings over a time period, hours of operation, utility arranged curtailment, lighting depreciation compensation, by-pass mode operation, light level and calibration. Additional, different or fewer parameters may be used for determining an amount of power reduction. In one embodiment, a power savings mode defaults to 15% or more reduction in power provided to the loads 12. The user selectable amount of power reduction provides sufficient light while minimizing the current or power used.

The power reduction units 16 are operable to increase or decrease the power provided to the loads 12 as a function of a desired power savings over a time period. The amount of power reduction is altered to provide an aggregate power savings over the time period, such as over a year. Where one power reduction unit 16 fails, the other power reduction units 16 are altered to increase the power reduction to account for the failed unit and avoid a decrease in the power savings.

The optional processor 18 comprises a personal computer, a general processor, an application specific integrated circuit, digital signal processor or other processor for controlling the power reduction units 16. The processor 18 operates using Scada Vision software from United Controls Corporation, but other software may be used. In one embodiment, the processor 18 is included in the power reduction units 16. In an alternative embodiment, the processor 18 is separate from one or all of the power reduction units 16. The processor 18 controls one or multiple power reduction units 16. For example, the processor 18 may be remote from one or more of the lighting control unit 16, so an electronic communications link, such as wireless, phone, hard wire or other connection is provided to each of the power reduction units 16.

The processor 18 electronically connects with power reduction units 16 to over-ride operation of one or more power reduction units 16. The processor 18 may also provide control instructions for regular operation of the power reduction units 16. The processor 18 monitors the operation of the power reduction units 16 and causes the power reduction units 16 to decrease the amount of power provided to the loads 12 when the power reduction provided by another of the units 16 decreases. The processor 18 may also control the standard or default power savings mode of the lighting control unit 16, such as controlling an initial amount of power reduction based on a desired aggregate power reduction over a time period and/or other parameters.

The optional user interface 22 comprises a keyboard, buttons, trackball, mouse or other input device for configuring operation of the processor 18 or power reduction units 16. The user interface 22 is electronically connected to the processor 18 or is physically part one or each of the power reduction units 16. A user inputs various parameters, such as indicating a desired aggregate power savings and a time period for accomplishing the power savings. Either of a total kilowatts, cost, or percent reduction for the system 10 over the time period is entered. Parameters limiting any automatic alterations to account for the target power savings over a time period are also entered, such as not exceeding a 50% reduction for any lighting loads 12, allowing a selected tolerance in power savings, limiting the number of alterations in a given time period or other limits.

A lamp age or time of relamping, curtailment operation parameters for further reducing loads to utilities, a schedule of operation (e.g. days and times in which lights are automatically turned off or on), selection of additional input (e.g. a light sensor associated with the area lit by the lamps 12), or other parameters may also be entered. One or more different circuits or groups of devices for different operation may also be configured, such as inputting the number of power reduction units 16, number of input/output blocks, number of power meters, and grouping of power reduction units 16 and/or loads 12 for differential operation. Any of the various parameters may be programmed within the processor 18 or power reduction units 16 without user input on the user interface 22, such as through communications with the server 20 or programming during manufacture.

The user interface 22 also allows selection or entry of communication information. For example, a phone number, mail server URL, mail server user ID, mail server password or other information is programmed into the processor 18. The processor 18 in one embodiment includes a communication card or circuit, such as a modem or Ethernet communications card. The communications card allows electrical connection with the server 20 or another processor. For example, the processor 18 sends data over a direct phone link or over a compute network using email-type communications. For an example of a power savings network, associated processor 18 and servers 20, see U.S. Pat. Nos. ______, and ______, (U.S. application Ser. No. 09/454,775, filed Dec. 3, 1999 and 09/541,264, filed Apr. 3, 2000), assigned to the assignee of the present invention, the disclosures of which are incorporated herein by reference. The processor 18 sends information regarding operation of the loads 12 and power reduction units 16 to the server 20 for archiving and analysis. Alarms, such as loss of alternating current, operation bypass or no savings mode, communications failure, fault or lack of operation of the power reduction units 16, unplugging of the communications link, unit failure and a general report, are provided to the server 20. Additional, less or different information may be provided. Information is exchanged between any two components on a regular basis, such as every minute, hourly, weekly or daily or exchanged based on event triggers.

The optional server 20 comprises a processor, network server, personal computer, or other device for communicating with one or more processors 18 or power reduction units 16. For example, the server 20 is provided by a power system monitoring or control company to operate or manage the loads of various customers. The server 20 provides diagnostic information or control information to the processor 18 or power reduction units 16.

One or more of the server 20, the processor 18, or power reduction units 16 comprise a controller for monitoring and altering the amount of power provided to the one or more loads 12 as a function of a target power savings over a time period. A monitoring program is implemented on one or more of the control unit 15 components for altering power reductions. The control unit 15 measures or receives measurements of the amount of power output to each load 12. The control unit 15 is operable to reduce an amount of power output to one or more loads 12 from the alternating current source 14 and automatically alter the reduction of the amount of power output as a function of a power savings over a time period. For example, the control unit 15 compares a current power savings to an amount needed to provide a target aggregate energy cost savings, total kilowatts or other power value by the end of the time period, such as at least a month or a year. When the current combined power savings by the power reduction units 16 may not lead to the target aggregate power savings, the control unit 15 causes at least one of the power reduction units 16 to alter the reduction of the amount of power output. For example, multiple of the power reduction units 16 increase respective reductions of amounts of power output in response to one of the power reduction units 16 decreasing a respective reduction of power output, keeping the current total power saving for the system 10 constant and within tolerances to provide the target aggregate power savings by the end of the time period. For at least one of the power reduction units 16, the reduction of the amount of power output is increased in response to a reduction in the power savings of the system 10.

In alternative embodiments, the control unit 15 is operable to increase a power reduction in response to a previous decrease of power reduction within the time period. For example, a single power reduction unit 16 fails by not reducing power for a day or more. Once the power reduction unit 16 is operational, the control unit 15 determines an adjustment or increase in power reduction for the power reduction unit 16 in the remaining period of the target time period or over a lesser time to meet the target aggregate power savings. Any combination of adjusting other power reductions units 16 within the system 10 and adjusting one unit 16 over time may be used to compensate for unexpected or undesired reductions in power savings.

FIG. 2 is a flowchart diagram of a method for controlling financial compensation based on reduced energy consumption in a power savings mode. Using the system 10 of FIG. 1 or another system, power reduction provided to a load in a power savings mode of operation is monitored and adjusted to meet a target aggregate power savings by the end of a time period. Instantaneous or current power reduction is adjusted based on the longer term power savings goal. Different, additional or fewer acts than shown in FIG. 2 may be used in alternative embodiments.

The aggregate target power savings is established with a contract, agreement or on another basis. Aggregate power savings indicates a total power savings by the end of the time period, such a total cost savings or kilowatts during a one year time period. For example, a performance contract is signed to provide $365 dollars a year in lighting costs savings. The system provides $1 a day in power savings for an aggregate power savings of $365 by the end of the year. As another example, one kilowatt per hour power savings results an aggregate 100 kilowatts of power savings over a 100 hour time period.

In act 30, the aggregate target power savings is entered into a monitoring program or software of the control unit 15. The monitoring program implements power reduction and adjustment of the reduction automatically or without further user input. In alternative embodiments, the monitoring program sends a request or warning for activation by the user. The aggregate target power savings is entered as a total energy cost savings, such as $365, with a known or also entered kilowatt per hour energy cost. Alternatively, a total kilowatt or kilowatts per hour savings by the end of the time period is entered. The time period is also entered, but may alternatively be a default value, such as a year. In alternative embodiments, a target power savings for a lesser time period is entered and used to calculate the target power savings for the greater time period, such as entering a daily or monthly power savings for a year based performance contract. Other values allowing calculation of the target power savings over a time period or instantaneous power savings values may be used. The monitoring program converts the aggregate target power savings to a value, such as a total kilowatts or kilowatts per hour, comparable to power information received from the loads 12 or power reduction units 16.

The monitoring program also determines a daily, hourly, weekly or instantaneous power savings to provide the target power savings by the end of or over the time period. First, the power reduction units 16 measure the power, such as voltage and current, at full power operation. U.S. Pat. Nos. 5,583,423 and 5,754,036 disclose systems for reducing power and measuring operation at full power. Added or separate power meters are alternatively used. In an alternative embodiment, a historical or average full power is known or stored. For example, a monthly or yearly electric bill provides the average full power for each load 12 and is entered for use by the monitoring program as full power. Seasonal, daily, hourly, weekly or other variances may also be measured or entered and used to determine full power at a given time. Periodic full power operation and measurements may be performed to assure continued accuracy throughout the time period.

Second, an instantaneous power reduction sufficient to provide the aggregate target power savings over the time period is calculated. For example, the target power savings of 365 kilowatts a year is entered. The monitoring program determines that a 20% reduction from full power by all of the power reduction units 16 provides 365 kilowatts a year or one kilowatt a day in power savings. In alternative embodiments, different ones of the power reduction units 16 are reduced at different amounts, such as based on different types of loads 12 or different limitations of the loads 12. Daily, weekly or seasonal variations in the power reduction for one or more of the power reduction units 16 may also be provided based on programming, user entered limitations on reduction, and variation of the full power. The monitoring program calculates a reduction for each power reduction unit 16 or each group of power reduction units 16 throughout the time period to provide the target power savings by the end of the time period. In one embodiment, the target power savings over the time period is set above the entered target power savings automatically to provide tolerance, but the same value may be used.

In act 32, the amount of power output to the loads 12 from the AC source 14 is reduced in a power savings mode of operation. For example, one of the power reduction units 16 reduces the amount of power output to a lighting load. Each of the power reduction units 16 reduces the power based on the calculated instantaneous power savings to provide the target power savings over the time period. For example, a 30%, 20% or other amount of power savings associated with a reduction in power with a minimal loss of lighting intensity is provided. Greater or lesser percentages may be used. Any of a reduction in peak voltage, RMS voltage, peak current, RMS current or other waveform characteristic is altered to provide the reduced power in the power savings mode of operation.

In act 34, the power savings or power reductions for each of the power reduction units 16 or loads 12 is monitored. Each power reduction unit 16 continues to measure the power provided to the load 12, such as measuring the voltage and current. The measured power or load is compared to the power at full power operation and a savings is calculated. Alternatively, the power reduction units 16 confirm continued operation at a particular power reduction or percentage of full power. The instantaneous power reductions are measured continuously, every second, every minute or other time period.

One of the power reduction units 16, the processor 18 or the server 20 calculates a total power reduction from the individual power reductions. For example, each power reduction unit 16 communicates the instantaneous power reduction to the processor 18 in response to a poll request from the processor 18. The processor 18 sums the returned values. Alternatively, the values are pushed to the processor 18 without polling. In another embodiment, the reduction values are not summed. In other embodiments, each power reduction unit 16 provides a current power savings to date value.

In act 36, any decrease in the power reduction is detected. Either an individual instantaneous power savings value or the total power savings is compared to expected values or a threshold. When the power reduction is less than the threshold, a decrease is identified. Alternatively, a decrease is detected in response to a power reduction unit 16 indicating a failure in the power savings mode. The power reduction decreases or the power to the loads 12 increases due to failure of a power reduction unit 16, due to changes in the load 12, due to variances in the use of the load 12, due to ambient feedback or a light sensor for altering reduction in response to needed light levels or for other reasons. Either by detecting a difference in power provided to the load 12 or by a communication indicating a change in status, the control unit 15 detects a power reduction of sufficient magnitude to risk not providing the target power savings over the time period at current instantaneous operation.

In act 38, the amount of power output is altered as a function of the aggregate target power savings over a time period. An increased power reduction to meet the aggregate target power savings by an end of a time period is calculated in response to the decrease in the power reduction. The amount of power output is decreased as a function of both the detected decrease in the reduction and the aggregate target power savings or as a function of the total power reduction being provided and the target power savings. For example, the amount of detected reduction of the power savings is distributed equally among operational power reduction units 16, such as increasing the power reduction of two units 16 by 5 kilowatts per hour or a percentage to account for a lack of 10 kilowatt per hour power savings by a failed or changed reduction of a third unit 16. This distribution compensates for the change in reduction to provide the target power savings by the end of the time period. In alternative embodiments, the decrease in reduction is distributed unequally, such as applying the amount to a single or group of power reduction units 16 according to a priority and any limits on individual reduction. Other application of the changed reduction by groups, with different amounts for different loads 12 or other distributions may be used.

The alteration is implemented automatically. The monitoring program calculates the changes to any reduction for satisfying the target power savings over a time period without human response or control at the time of alteration. Alternatively, the user authorizes, determines or otherwise controls the alteration. The power reduction units 16 receive controls or respond to the software by altering the amount of power reductions, such as by increasing the reduction.

The alteration may also result in a decrease in reduction, such as where a failed power reduction unit 16 becomes operational or where a change in a load 12 results in an increase in reduction at a same percentage. The change is detected, and the monitoring program alters to compensate while maximizing the light or power output without risking exceeding the aggregate target power savings by the end of the time period. Alternatively, the current reductions are maintained, and any extra power savings are accrued for increasing the likelihood of meeting the target power savings over time.

During the time period for aggregate power savings, the instantaneous power reduction amount or percentage of each, some, all or none of the power reduction units 16 is altered. The instantaneous total power reduction is maintained throughout the time period by adjusting power reduction of one or more units 16. By maintaining the instantaneous total power reduction, the target power savings by the end of the time period is satisfied. In alternative embodiments, the instantaneous total power reduction varies, such as daily, so that the aggregate power savings over the time period is satisfied but more power is provided to the loads at certain times, such as during the day. By maintaining or altering the actual power savings over the time period, the actual power savings at the end of the time period is at or below the aggregate target power savings. For example, a total 1 kilowatt per hour savings is provided over a month so that an aggregate 720 kilowatts are saved. One or more of the power reduction units 16 is altered to maintain the 1 kilowatt per hour savings during the month. In alternative embodiments, the instantaneous total power savings varies above or both below and above a value corresponding to meeting the target power savings over the time period. Any power savings below the desired amount is off-set by power savings above the amount during the time period.

Any excess power savings greater than the aggregate target power savings by the end of the time period may be to the benefit of the user or customer. Alternatively, the excess power savings is accounted for in future time periods. For example, the excess is banked for when failures or other reductions in the power savings at the end of a time period cannot or are not off-set before the end of the time period. The excess power savings from the earlier time period contractually compensates for the failure to meet the target power savings in another time period. Alternatively, the excess allows for increased power to the loads during a subsequent time period without contractual penalty (i.e. the excess reduces the target power savings for one or more later time periods).

The monitoring program may perform other functions. In one embodiment, a report of power savings to date, settings of the system 10 at a given time, any failures or errors or other information is periodically generated. For example, every hour the processor 18 determines the settings of the various power reduction units 16. The settings are stored and included in a weekly report automatically generated and transmitted to the server 20. As another example, an SQL or other data base of failures or error conditions is generated and stored. A periodic report in ASCII or other format of the data base information is transmitted to the server 20. The report may be used to forecast estimated failures or trends for better planning. Any reports may also be generated in response to a request.

In one embodiment, the system 10 includes additional hardware and capabilities. A revenue accurate meter is provided for monitoring the power drawn from the utility. Communication power supplies and modules interconnect the various components of the system 10. An uninterrupted power supply for operation of the system 10 during an interruption in power from the AC source 14 is provided. Various wiring harnesses and jumpers for interconnecting the components are also provided. The processor 18 and/or the power reduction units 16 are adapted for mounting to a wall or desk or as cards for mounting in a circuit box.

The system 10 of a further embodiment is an automatic lighting management system using the ScadaVision software (e.g. both client and server versions). Various power reduction units 16 are grouped to function in dissimilar ways by group. Within a grouping of power reduction units 16, additional areas of differentiated control may be provided for fine-tuning particular circuits. Various functions and features are available for each grouping or area within a grouping, such as the hours of operation, switching between different power savings levels based on occupancy (e.g. using motion sensors to determine when someone is in the room to decrease the amount of power savings), automatic switching between power savings level as a function of the time of day, curtailment for allowing power reduction to be increased to a greater savings level or shut off for utility curtailment programs, altering the amount of power savings as a function of the ambient light, lighting depreciation compensation, by-pass operation for normal full power operation and calibration operation for verifying power savings. Fewer, different or additional features may be provided.

In this embodiment, a monitoring system comprising three servers 20 is used, but more or fewer servers 20 may be provided. The servers 20 connect with multiple customers. A mail server receives alarms from each customer, another server monitors the mail server, constructs the database or archived information and routes alarms to an alarm server. The alarm server receives the alarms and historical power measurement information to construct a redundant database. Using the various servers 20, the system 10 is controlled remotely, and audio or visual alerts are provided for each customer at a central location. Maintenance personnel are dispatched immediately after an alarm is received or scheduled as a function of alarms for more immediate repair of lighting at the appropriate customer. Other network configurations and modes of operation may be provided.

While the invention has been described above by reference to various embodiments, it should be understood that many changes and modifications can be made without departing from the scope of the invention. For example, a user enters a target instantaneous power savings and the system 10 maintains the instantaneous power savings. The monitoring program may not use the time period or aggregate power savings information to provide a desired aggregate power savings. It is therefore intended that the foregoing detailed description be regarded as illustrative rather than limiting, and that it be understood that it is the following claims, including all equivalents, that are intended to define the spirit and scope of this invention.

I (we) claim:

1. A system for controlling financial compensation based on reduced energy consumption in a power savings mode, the system comprising:
an alternating current source;
a load; and
a control unit connected with the load, the control unit operative to reduce an amount of power output to the load from the alternating current source and automatically alter the reduction of the amount of power output as a function of a power savings over a time period.

2. The system of claim 1 wherein the power savings comprises an energy cost savings.

3. The system of claim 1 wherein the power savings comprises kilowatts per hour.

4. The system of claim 1 wherein the power savings over a time period comprises a contractual savings over at least a month.

5. The system of claim 4 wherein the contractual savings is over at least a year.

6. The system of claim 1 wherein the control unit is operable to increase the reduction of the amount of power output in response to a reduction in the power savings.

7. The system of claim 1 wherein the load comprises a lighting load and the control unit comprises a lighting control unit.

8. The system of claim 1 wherein the control unit is operable to measure the amount of power output.

9. The system of claim 1 wherein the control unit comprises a processor connected with a plurality of power reduction units, the processor operable to cause at least one of the power reduction units to alter the reduction of the amount of power output as a function of the power savings over the time period based on a combined power savings by the plurality of power reduction units.

10. The system of claim 9 wherein the processor is operable to cause multiple of the power reduction units to increase respective reductions of amounts of power output in response to one of the power reduction units decreasing a respective reduction of power output.

11. A method for controlling financial compensation based on reduced energy consumption in a power savings mode, the method comprising:
(a) reducing an amount of power output to a load from an AC source; and
(b) altering the amount of power output as a function of an aggregate target power savings over a time period.

12. The method of claim 11 further comprising:
(c) inputting the aggregate target power savings as an energy cost savings for the time period;
wherein (b) comprises altering the amount so that an actual power savings over the time period is at or less than the aggregate target power savings.

13. The method of claim 11 further comprising:
(c) inputting an aggregate target power savings as a kilowatts per hour for the time period;
wherein (b) comprises altering the amount so that an actual power savings over the time period is at or less than the aggregate target power savings.

14. The method of claim 11 wherein the aggregate target power savings over a time period comprises a contractual savings over at least a month.

15. The method of claim 11 further comprising:
(c) detecting a decrease in the reduction of (a);
wherein (b) comprises decreasing the amount of power output as a function of both the decrease in the reduction of (a) and the aggregate target power savings.

16. The method of claim 15 wherein (a) comprises reducing the amount of power output to a lighting load.

17. The method of claim 11 further comprising:
(c) monitoring respective power savings for each of at least two power reduction units;
wherein (b) comprises compensating for a reduction in power savings by a first one of the at least two power reduction units with an increase in power savings by a second one of the at least two power reduction units.

18. The method of claim 17 wherein (b) comprises maintaining a total power savings provided by the at least two power reduction unites at any given time such that the aggregate target power savings is met at the end of the time period.

19. The method of claim 11 further comprising:
(c) establishing the aggregate target power savings with a contract; and
(d) entering the aggregate target power savings into a monitoring program wherein the monitoring program implements (a) and (b) automatically.

20. The method of claim 19 wherein (b) comprises providing for a greater power reduction over the time period than the aggregate target power savings; and
further comprising:
(e) compensating for a later failure to meet the aggregate target power savings with any excess power savings.

21. A method for controlling financial compensation based on reduced energy consumption in a power savings mode, the method comprising:
(a) monitoring power reductions for each of a plurality of loads;
(b) calculating a total power reduction from the power reductions; and
(c) automatically altering power reductions for multiple of the plurality of loads in response to a decrease in the power reduction provided to one of the plurality of loads, the altering being as a function of a target power savings and the total power reduction.

22. The method of claim 21 wherein (c) comprises maintaining the total power reduction at a target power savings.

23. The method of claim 21 further comprising:
(d) calculating an increased power reduction to meet an aggregate target power savings by an end of a time period in response to the decrease in the power reduction.
